(19) United States
(12) Patent Application Publication
(10) Pub. No.: US 2012/0327143 A1
(43) Pub. Date: Dec. 27, 2012

(54) LCD device and a related driving method

(75) Inventor: Chihtsung Kang, Shenzhen (TW)

(73) Assignee: SHENZHEN CHINA STAR OPTOELECTRONICS TECHNOLOGY CO., LTD., Shenzhen (CN)

(21) Appl. No.: 13/375,225

(22) PCT Filed: Aug. 26, 2011
(86) PCT No.: PCT/CN2011/078958

§ 371 Date: Nov. 30, 2011

(30) Foreign Application Priority Data
Jun. 24, 2011 (CN) 201110173971.2

(51) Int. Cl. G09G 3/36; G09G 5/02

(52) U.S. Cl. 345/694; 345/88

(57) ABSTRACT

The present invention discloses an LCD device and related driving device and driving method. The driving method includes: obtaining an accumulated working time of the LCD device; obtaining a high reference voltage corresponding to the accumulated working time; utilizing the high reference voltage to drive the LCD device; making a multiplying product of a transmittance and a backlight magnitude of the LCD device remain equal or proximity. The present invention suppresses the backlight magnitude decrease phenomenon due to the long-used term of the LCD device such that the display quality can be improved.

### BACKGROUND OF THE INVENTION

1. Field of the Invention

The invention relates to a display and a related driving method, and more particularly, to an LCD device and a related driving method for driving the LCD device.

2. Description of the Prior Art

Over-driving technique is often used to improve the display quality of the LCD device. Conventionally, the over-driving technique is accomplished by looking up a table according to the previous and a current frame data to find out a predetermined interpolated voltage, and providing the over-driving voltage on the pixel to reduce the response time.

However, a frame buffer is required to store the previous frame such that the previous frame can be compared with the current one. Furthermore, the above-mentioned predetermined interpolated voltages are also needed to be stored inside a storage device. Moreover, a timing controller (TCON) is also required.

Please refer to FIG. 1, which depicts the over-driving function accomplished by a column-driving configuration. Here, the original signal is transformed from 1V (where the positive/negative voltages are respectively 6V and 4V) to 3V (where the positive/negative voltages are respectively 8V and 2V). In order to improve the response speed, a signal 5V (where the positive/negative voltages are respectively 10V and 0V) is often inserted into the original signal. When the voltage of the pixel changes from 1V to 3V, it needs one frame period to perform the charging operation such that a 5V voltage can be obtained.

For PVA panel, because a high transmittance is required, each pitch between two adjacent grid electrodes of the pixel electrodes is designed to be greater. In this case, if only one set of interpolated voltages are recorded inside the look-up table, the liquid crystals may be driven instantly to rotate through an incorrect angle. This also introduces an overshooting phenomenon when the pixel is transformed from a low gray level to a high gray level such that the display quality is reduced.

Therefore, an LCD device and a driving method for driving the LCD device are required to solve the above-mentioned problem.

### SUMMARY OF THE INVENTION

It is therefore one of the primary objectives of the claimed invention to provide an LCD device capable of performing the over-driving operation in one frame period.

According to an exemplary embodiment of the claimed invention, an LCD device is disclosed. The LCD device comprises: a scan driving module, for generating scan signals; data driving module, for generating data signals; TFT array panel, having pixels, each of the pixels comprises a sub-pixel R, a sub-pixel G, and a sub-pixel B; scan lines, coupled to at least one sub-pixel of the pixels, for receiving the scan signals from the scan driving module to row-by-row scan the sub-pixels located on a same column; data lines, coupled to at least one sub-pixel of the pixels, for receiving the data signals from the data driving module, pre-charging the sub-pixel before transferring the data signals to the sub-pixel, and transferring the data signals to display an image; and common lines, coupled to at least one sub-pixel of the pixels, for providing a high voltage or a low voltage according to a polarity of the sub-pixel coupled to the common line; wherein the sub-pixels R, G and B are arranged in a horizontal direction or a vertical direction of a scanning direction of scanning the sub-pixels, the common line is orthogonal to the scanning direction of scanning the sub-pixels, and two adjacent pixels have opposite polarities.

In the LCD device according to the present invention, each of the common lines is coupled to the sub-pixels having a same polarity.

In the LCD device according to the present invention, each of the data lines is coupled to the sub-pixels having a same polarity.

According to an exemplary embodiment of the claimed invention, an LCD device is disclosed. The LCD device comprises: a scan driving module, for generating scan signals; a data driving module, for generating data signals; a TFT array panel, having pixels, each of the pixels comprises a sub-pixel R, a sub-pixel G, and a sub-pixel B; scan lines, coupled to at least one sub-pixel of the pixels, for receiving scan signals from the scan driving module, to row-by-row scan the sub-pixels located on a same column; and data lines, coupled to at least one sub-pixel of the pixels, for receiving the data signals from the data driving module, pre-charging the sub-pixel before transferring the data signals to the sub-pixel, and transferring the data signals to display an image.

In the LCD device according to the present invention, the LCD device further comprises common lines, coupled to at least one sub-pixel of the pixels, for providing a high voltage or a low voltage according to a polarity of the sub-pixel coupled to the common line.

In the LCD device according to the present invention, the sub-pixels R, G and B are arranged in a horizontal direction of a scanning direction of scanning the sub-pixels.

In the LCD device according to the present invention, the sub-pixels R, G and B are arranged in a vertical direction of a scanning direction of scanning the sub-pixels.

In the LCD device according to the present invention, the common line is orthogonal to the scanning direction of scanning the sub-pixels.

In the LCD device according to the present invention, two adjacent pixels have opposite polarities.

In the LCD device according to the present invention, each of the common lines is coupled to the sub-pixels having a same polarity.

In the LCD device according to the present invention, each of the data lines is coupled to the sub-pixels having a same polarity.

According to an exemplary embodiment of the claimed invention, a driving method for driving an LCD device is disclosed. The LCD device comprises a scan driving module, a data driving module, a TFT array panel, scan lines, and data lines, the TFT array panel have pixels, each of the pixels comprises a sub-pixel R, a sub-pixel G, and a sub-pixel B, the driving method comprises: (A) utilizing the scan driving module to generate scan signals and transferring the scan signals to the scan lines; (B) utilizing the data driving module to generate data signal and transferring the data signals to the data lines; (C) utilizing the scan lines to transfer the scan signals to at least one sub-pixel of the pixels to row-by-row scan sub-pixels located in a same column; (D) utilizing the data lines to pre-charge at least one sub-pixel of the pixels, and to transfer the data signals to the sub-pixel in order to display an image.

In the LCD device according to the present invention, the driving method comprises: (E) utilizing common lines to provide a high voltage or a low voltage to the sub-pixels coupled to the common lines.

In contrast to the related art, the present invention does not need the frame buffer such that the cost is reduced. Furthermore, a complicated timing function is not required to perform the over-driving operation. Moreover, the pixels are not instantly driven to rotate through an incorrect angle if a prior art method of looking up tables to perform the over-driving operation.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an over-driving operation according to the prior art.

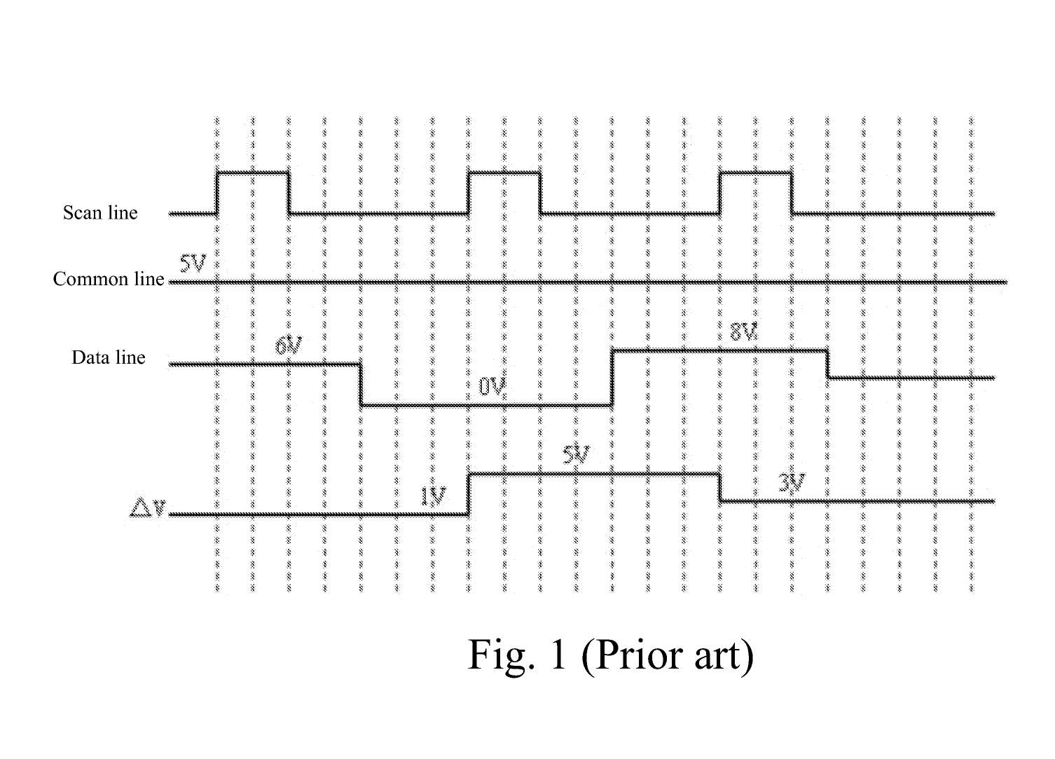

FIG. 2 is a block diagram of an LCD device according to the present invention.

FIG. 3 is a diagram showing a part of the LCD device according to a first embodiment according to the present invention.

FIG. 4 is a diagram showing driving signals of the LCD device according to the present invention.

FIG. 5 is a diagram showing a part of the LCD device according to a second embodiment according to the present invention.

FIG. 6 is a diagram showing a part of the LCD device according to a third embodiment according to the present invention.

FIG. 7 is a diagram showing a part of the LCD device according to a fourth embodiment according to the present invention.

### DETAILED DESCRIPTION OF THE PREFERRED EMBODIMENT

In the following disclosure, units having similar function are labeled as the same number.

The LCD device of the present invention utilizes a high voltage to charge pixels before the data signals are inputted into the pixels through the pre-charge operation and high/low level signals of the array common lines. This is equal to perform an over-driving operation before the data signals are inputted into the pixels.

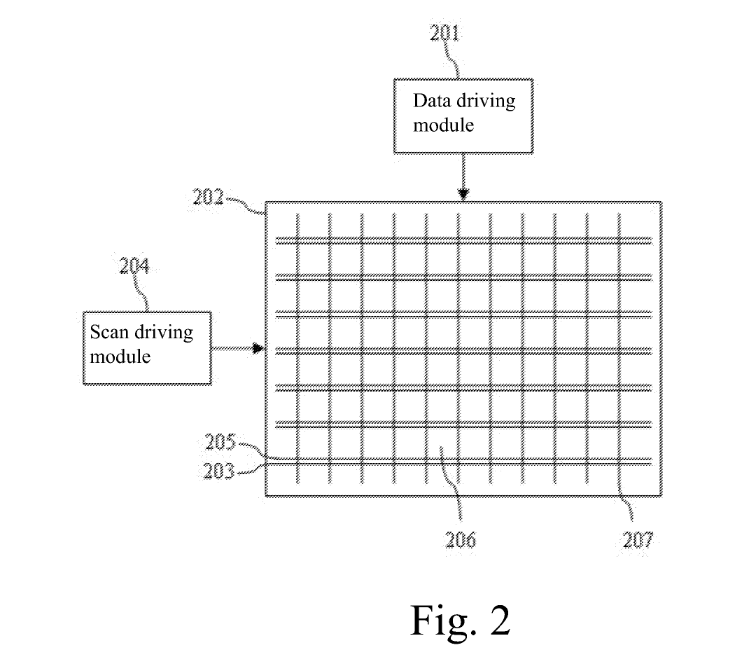

Please refer to FIG. 2, which is a block diagram of the LCD device according to the present invention. The LCD device comprises an scan driving module 204, a data driving module 201, a TFT array panel 202, common lines 205, scan lines (gate lines) 203, and data lines 207. In FIG. 2, the scan lines 203 and the data lines 207 are orthogonal. The TFT array panel 102 has pixels 206. The pixel 206 comprises three sub-pixels (now shown). The scan driving module 204 is used to generate scan signals (gate signals) and transfer the scan signals to the scan lines 203. The data driving module 201 is used to generate data signals and transfer the data signals to the data lines 207. The scan lines 203 are coupled to the pixels 206. To speak more specifically, each of the scan lines 203 is coupled to at least one sub-pixel of the pixel 206. The data lines 207 are coupled to the pixels 206. To speak more specifically, each of the scan lines 207 is coupled to at least one sub-pixel of the pixel 206. The common lines 205 are coupled to the pixels 206. To speak more specifically, each of the common lines 205 is coupled to at least one sub-pixel of the pixel 206.

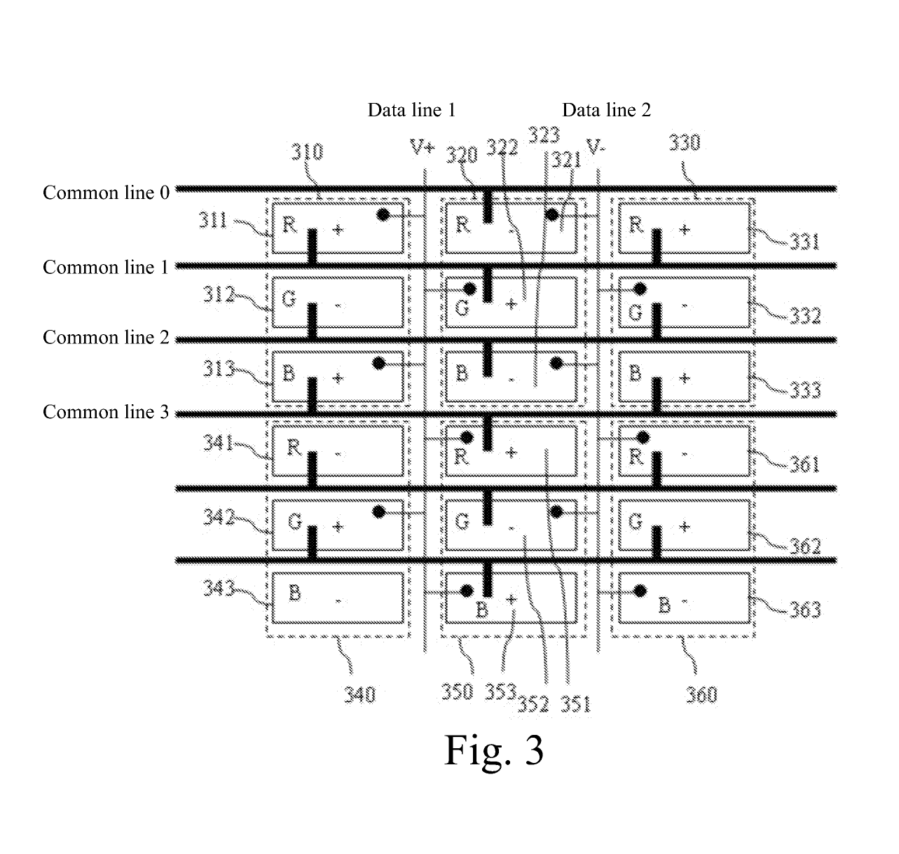

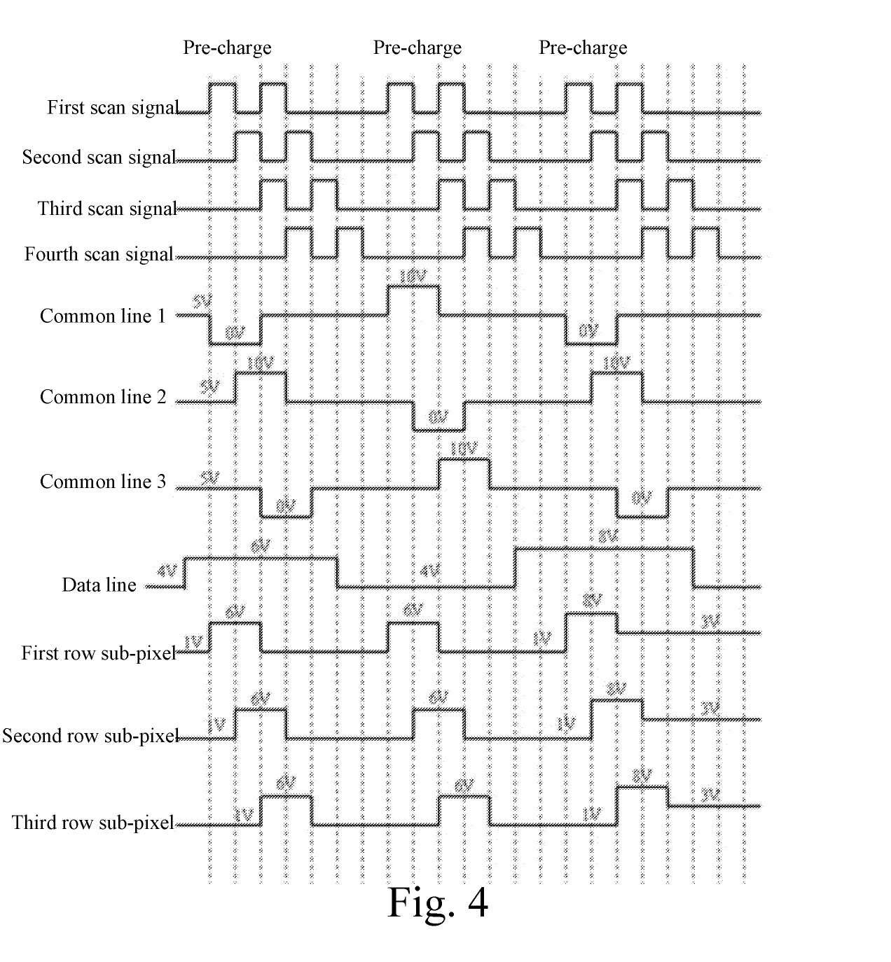

Please refer to FIG. 3 in conjunction with FIG. 4. FIG. 3 is a part of the LCD device according to the first embodiment of the present invention. FIG. 4 is a diagram showing driving signals of the LCD device according to the present invention. In this embodiment, tri-gate is composed of three sub-pixels (sub-pixel R, sub-pixel G, and sub-pixel B). The sub-pixels R, the sub-pixels G, and the sub-pixels B are respectively arranged parallel to the scanning direction.

In this embodiment, the data line is designed according to the flip pixel configuration. That is, the data lines (including the data line 1 and the data line 2) are arranged along the arranging direction of the sub-pixels R, G, and B. In addition, each of the data lines is coupled to the first and last sub-pixels of a pixel and a middle sub-pixel of the pixel vertically next to the pixel. For example, the data line 1 is coupled to the sub-pixels R311 and B313 of the pixel 310, sub-pixel G322 of the pixel 320, the sub-pixels R351 and B353 of the pixel 350, and the sub-pixel 342 of the pixel 340. The common lines (including the common line 0, the common line 1, the common line 2, and the common line 3) are vertical to the data lines, and they are arranged as an array. In this embodiment, each of the common lines is coupled to a specific sub-pixel of two pixels, and another sub-pixel of another pixel, which is between the two pixels. Specifically, the common line 1 (com 1) is coupled to the sub-pixel R311 of the first pixel 310, the sub-pixel G322 of the second pixel 320, and the sub-pixel R331 of the third pixel 330. The common line 2 (com 2) is coupled to the sub-pixel G312 of the first pixel 310, the sub-pixel B323 of the second pixel 320, and the sub-pixel G332 of the third pixel 330. The common line 3 (com 3) is coupled to the sub-pixel B313 of the first pixel 310, the sub-pixel R351 of the fifth pixel 350, and the sub-pixel B333 of the third pixel 330. The first pixel 310 is adjacent to the second pixel 320. The polarity of the first pixel 310 is opposite to the polarity of the second pixel 320. Similarly, the first pixel 310 is adjacent to the second pixel 340, and the polarity of the first pixel 310 is opposite to the polarity of the second pixel 340.

In FIG. 4, the present invention LCD device does not need one frame period to charge the pixels. This is because before the pixel voltage changes from 1V to 3V, a corresponding data signal having 8V voltage has been used to pre-charge the pixel in the same frame. The above-mentioned pixel voltage 1V is accomplished by utilizing the data signal 6V and common line signal 5V or the data signal 4V and common line signal 5V to charge the pixel. The pixel voltage 3V is accomplished by utilizing the data signal 8V and common line signal 5V or the data signal 2V and common line signal 5V to charge the pixel. The pre-charging voltage 8V is accomplished by utilizing the data signal 8V and the common line modulated signal 0V or the data signal 2V and the common line modulated signal 10V to charge the pixel.

The first scan signal is transferred to the sub-pixels of the first row (including sub-pixel R311 of the first pixel 310, sub-pixel R321 of the second pixel 320, and sub-pixel R331 of the third pixel 330). When the first scan signal corresponds to a high level, the gates of the sub-pixels of the first row are on. This makes the sub-pixels of the first row be pre-charged by the data signal 8V and the common line modulated signal 0V or the data signal 2V and the common line modulated signal 10V before the pixel voltage changes from 1V to 3V. In addition, when the first scan signal corresponds to a high level voltage, because the sub-pixels R311 and R331 correspond to a positive polarity data line 8V, this data line 8V can cooperate with the common voltage of the common line 1, which is modulated from 5V to 0V, to pre-charge the sub-pixels R311 and R331 to 8V. At the same time, the sub-pixel R321 corresponds to a negative polarity data line 2V. This data line 2V can cooperate with the common voltage 10V of the common line 0 to pre-charge the sub-pixel R321 to 8V. And then, the first scan signal corresponds to a low voltage such that the gates of the sub-pixels of the first row are off.

Similarly, the second scan signal is transferred to the sub-pixels of the second row (including sub-pixel G312 of the first pixel 310, sub-pixel G322 of the second pixel 320, and sub-pixel G332 of the third pixel 330). When the second scan signal corresponds to a high level, the gates of the sub-pixels of the second row are on. This also makes the sub-pixels of the second row be pre-charged by the data signal 8V and the common line modulated signal 0V or the data signal 2V and the common line modulated signal 10V before the pixel voltage changes from 1V to 3V. In addition, when the second scan signal corresponds to a high level voltage, because the sub-pixels G312 and G332 correspond to a negative polarity data line 2V, this data line 2V can cooperate with the common voltage of the common line 2, which is modulated from 5V to 10V, to pre-charge the sub-pixels G312 and G332 to 8V. At the same time, the sub-pixel R322 corresponds to a positive polarity data line 8V. This data line 8V can cooperate with the common voltage 0V of the common line 1 to pre-charge the sub-pixel G322 to 8V. And then, the second scan signal corresponds to a low voltage such that the gates of the sub-pixels of the second row are off.

Furthermore, the third scan signal is transferred to the sub-pixels of the third row (including sub-pixel B313 of the first pixel 310, sub-pixel B323 of the second pixel 320, and sub-pixel B333 of the third pixel 330). When the third scan signal corresponds to a high level, the gates of the sub-pixels of the third row are on. This also makes the sub-pixels of the third row be pre-charged by the data signal 8V and the common line modulated signal 0V or the data signal 2V and the common line modulated signal 10V before the pixel voltage changes from 1V to 3V. In addition, when the third scan signal corresponds to a high level voltage, because the sub-pixels B313 and B333 correspond to a positive polarity data line 8V, this data line 8V can cooperate with the common voltage of the common line 3, which is modulated from 5V to 0V, to pre-charge the sub-pixels B313 and B333 to 8V. At the same time, the sub-pixel B323 corresponds to a negative polarity data line 2V. This data line 2V can cooperate with the common voltage 10V of the common line 2 to pre-charge the sub-pixel B323 to 8V. When the third scan signal corresponds to a high level, the first scan signal corresponds to a high level. Because the sub-pixels R311 and R331 both correspond to the positive polarity data line 8V, the data line 8V can cooperate with the common voltage of the common line 1, which is back to 5V, to charge the sub-pixels R311 and R331 to the target voltage 3V. Simultaneously, the sub-pixel R321 corresponds to a negative data line 2V. The data line 2V can cooperate with the common voltage of the common line 0, which is back to 5V, to charge the sub-pixel R321 to the target voltage 3V.

And then, the fourth scan signal corresponds to a high level such that the gates of the sub-pixels of the fourth row are on, and so on. In this way, the over-driving operation can be finished in a frame period.

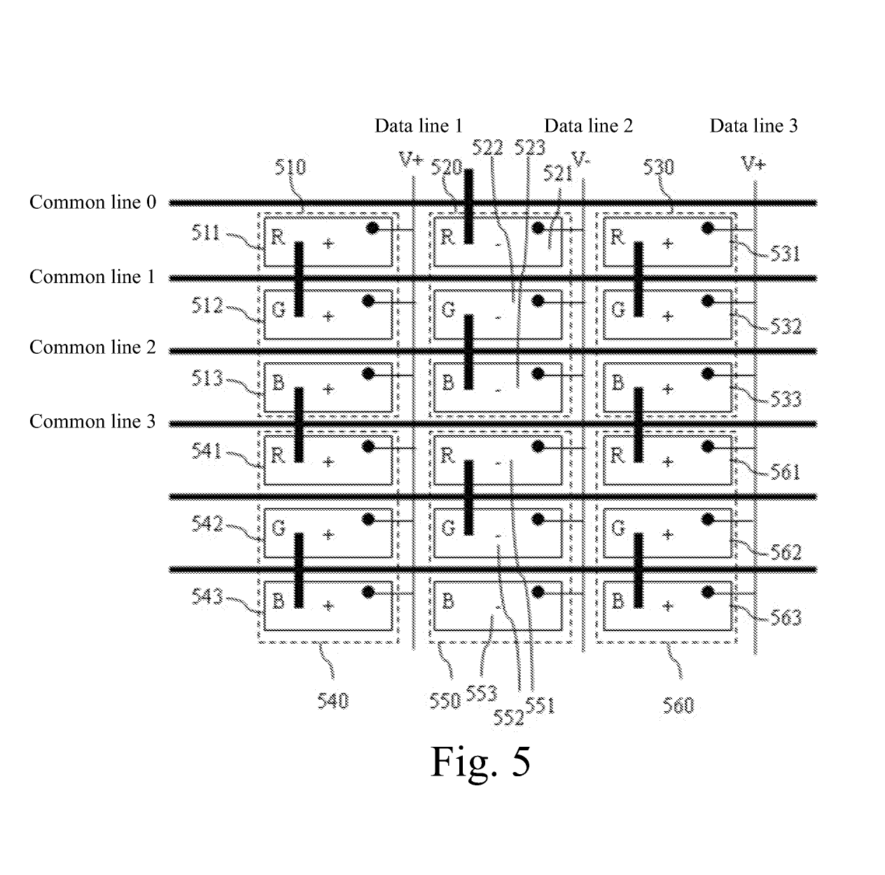

Please refer to FIG. 5, which is a diagram showing a part of the LCD device according to a second embodiment of the present invention. In this embodiment, the pixel is composed of three sub-pixels (sub-pixel R, sub-pixel G, and sub-pixel B). In addition, the pixels are row-by-row driven. The three sub-pixels in a pixel are arranged along a direction vertical to the scanning direction. In addition, a data line is coupled to all the three sub-pixels of a pixel according to the order of sub-pixel R, sub-pixel G, and sub-pixel B. The pixels are driven by a column driving configuration. The sub-pixels corresponding to the same column have the same polarity.

To speak more specifically, the data line 1 is coupled to the sub-pixels R511, G512, and B513 of the first pixel 510. The common line 1 is coupled to the sub-pixels R511 and G512 of the first pixel 510 and the sub-pixels R531 and G532 of the third pixel 530. The common line 2 is coupled to the sub-pixels G522 and B523 of the second pixel 520. The common line 3 is coupled to the sub-pixels B513 of the first pixel 510, the sub-pixel R541 of the fourth pixel 540, the sub-pixel B533 of the third pixel 530, and R561 of the sixth pixel 560. The common lines 1, 2, and 3 are arranged along a direction vertical to the data lines, and the common lines and data lines form an array. The first pixel 510 is adjacent to the second pixel 520, and they have opposite polarities.

Please refer to FIG. 5 in conjunction with FIG. 4. The first scan signal is transferred to the sub-pixels of the first row (including sub-pixel R511 of the first pixel 510, sub-pixel R521 of the second pixel 520, and sub-pixel R531 of the third pixel 530). When the first scan signal corresponds to a high level, the gates of the sub-pixels of the first row are on. This makes the sub-pixels of the first row be pre-charged by the data signal 8V and the common line modulated signal 0V or the data signal 2V and the common line modulated signal 10V before the pixel voltage changes from 1V to 3V. In addition, when the first scan signal corresponds to a high level voltage, because the sub-pixels R511 and R531 correspond to a positive polarity data line 8V, this data line 8V can cooperate with the common voltage of the common line 1, which is modulated from 5V to 0V, to pre-charge the sub-pixels R511 and R531 to 8V. At the same time, the sub-pixel R521 corresponds to a negative polarity data line 2V. This data line 2V can cooperate with the common voltage 10V of the common line 0 to pre-charge the sub-pixel R521 to 8V. And then, the first scan signal corresponds to a low voltage such that the gates of the sub-pixels of the first row are off.

Similarly, the second scan signal is transferred to the sub-pixels of the second row (including sub-pixel G512 of the first pixel 510, sub-pixel G522 of the second pixel 520, and sub-pixel G532 of the third pixel 530). When the second scan signal corresponds to a high level, the gates of the sub-pixels of the second row are on. This also makes the sub-pixels of the second row be pre-charged by the data signal 8V and the common line modulated signal 0V or the data signal 2V and the common line modulated signal 10V before the pixel voltage changes from 1V to 3V. In addition, when the second scan signal corresponds to a high level voltage, because the sub-pixels G512 and R532 correspond to a positive polarity data line 8V, this data line 8V can cooperate with the common voltage of the common line 2, which maintains 0V as high as the voltage when the first scan signal corresponds to a high level, to pre-charge the sub-pixels G512 and G532 to 8V. At the same time, the sub-pixel G522 corresponds to a negative polarity data line 2V. This data line 2V can cooperate with the common voltage of the common line 2, which is modulated from 5V to 10V, to pre-charge the sub-pixel G522 to 8V. And then, the second scan signal corresponds to a low voltage such that the gates of the sub-pixels of the second row are off.

Furthermore, the third scan signal is transferred to the sub-pixels of the third row (including sub-pixel B513 of the first pixel 310, sub-pixel B523 of the second pixel 320, and sub-pixel B533 of the third pixel 330). When the third scan signal corresponds to a high level, the gates of the sub-pixels of the third row are on. This also makes the sub-pixels of the third row be pre-charged by the data signal 8V and the common line modulated signal 0V or the data signal 2V and the common line modulated signal 10V before the pixel voltage changes from 1V to 3V. In addition, when the third scan signal corresponds to a high level voltage, because the sub-pixels B513 and B533 correspond to a positive polarity data line 8V, this data line 8V can cooperate with the common voltage of the common line 3, which is modulated from 5V to 0V, to pre-charge the sub-pixels B513 and B533 to 8V. At the same time, the sub-pixel B523 corresponds to a negative polarity data line 2V. This data line 2V can cooperate with the common voltage 10V of the common line 2 to pre-charge the sub-pixel B523 to 8V. When the third scan signal corresponds to a high level, the first scan signal corresponds to a high level. Because the sub-pixels R511 and R531 both correspond to the positive polarity data line 8V, the data line 8V can cooperate with the common voltage of the common line 1, which is back to 5V, to charge the sub-pixels R511 and R531 to the target voltage 3V. Simultaneously, the sub-pixel R521 corresponds to a negative data line 2V. The data line 2V can cooperate with the common voltage of the common line 0, which is back to 5V, to charge the sub-pixel R521 to the target voltage 3V.

And then, the fourth scan signal corresponds to a high level such that the gates of the sub-pixels of the fourth row are on, and so on. In this way, the over-driving operation can be finished in a frame period.

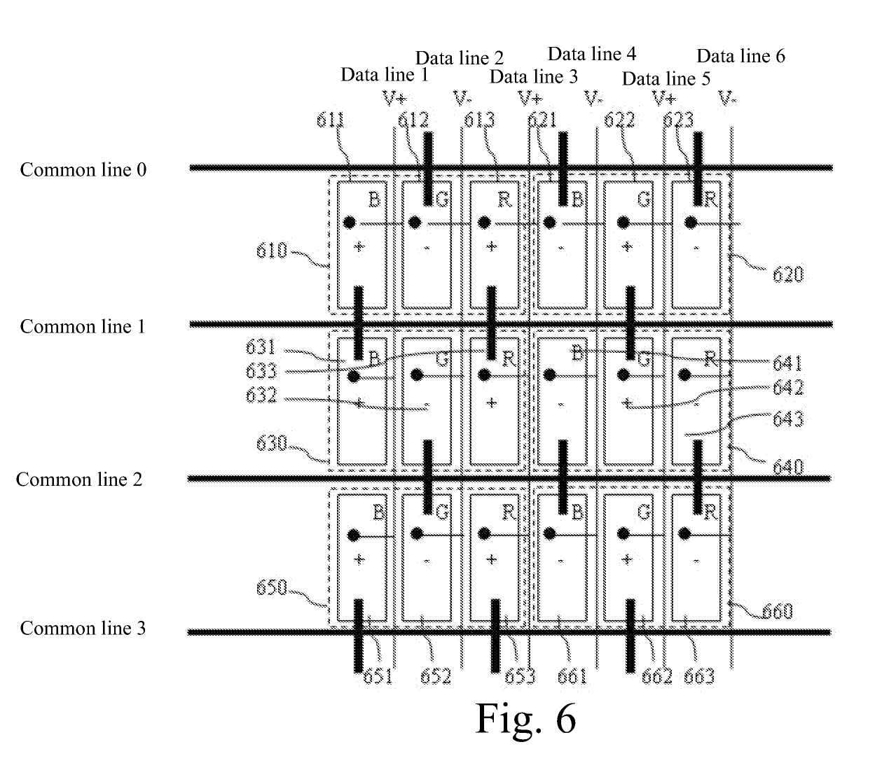

Please refer to FIG. 6, which is a diagram showing a part of the LCD device according to a third embodiment of the present invention. In this embodiment, the LCD device comprises a plurality of vertical-strip pixels, and each vertical-strip pixel is composed of three vertical-strip sub-pixels (sub-pixel R, sub-pixel G, and sub-pixel B). As shown in FIG. 6, the sub-pixels R, G, and B are arranged in a horizontal direction. The pixels are driven by a column driving configuration. The sub-pixels corresponding to the same column have the same polarity. The data lines are vertical to the arranging direction of the sub-pixels R, G, and B. Each of the data lines is coupled to the sub-pixels having the same polarity.

To speak more specifically, the data line 1 is coupled to the sub-pixel B611 of the first pixel 610, the sub-pixel B631 of the third pixel 630, and the sub-pixel B651 of the fifth pixel 650. The common lines 1, 2, and 3 are orthogonal to the data lines, and the common lines and the data lines form an array. In this embodiment, the common line 1 is coupled to the sub-pixel B611 of the first pixel 610, the sub-pixel B631 of the third pixel 630, the sub-pixel R613 of the first pixel 610, the sub-pixel R633 of the third pixel 630, the sub-pixel G622 of the second pixel 620, and the sub-pixel G642 of the fourth pixel 640. The common line 2 is coupled to the sub-pixel G632 of the third pixel 630, the sub-pixel G652 of the fifth pixel 650, the sub-pixel B641 of the fourth pixel 640, the sub-pixel B661 of the sixth pixel 660, the sub-pixel R643 of the fourth pixel 640, and the sub-pixel R663 of the sixth pixel 660. The coupling configuration of the common 3 can be referred to FIG. 6, and thus omitted here. The pixel 610 is adjacent to the pixel 620, and they have opposite polarity. In addition, the pixel 610 is adjacent to the pixel 630, and they have the same polarity.

Please refer to FIG. 6 in conjunction with FIG. 4. The first scan signal is transferred to the sub-pixels of the first row (including sub-pixels B611, G612, R613 of the first pixel 610, and the sub-pixels B621, G622, R623 of the second pixel 620). When the first scan signal corresponds to a high level, the gates of the sub-pixels of the first row are on. This makes the sub-pixels of the first row be pre-charged by the data signal 8V and the common line modulated signal 0V or the data signal 2V and the common line modulated signal 10V before the pixel voltage changes from 1V to 3V.

In addition, when the first scan signal corresponds to a high level voltage, because the sub-pixels B611, R613, and G622 correspond to a positive polarity data line 8V, this data line 8V can cooperate with the common voltage of the common line 1, which is modulated from 5V to 0V, to pre-charge the sub-pixels B611, R613, and G622 to 8V. At the same time, the sub-pixels G612, B621, and R623 correspond to a negative polarity data line 2V. This data line 2V can cooperate with the common voltage 10V of the common line 0 to pre-charge the sub-pixels G612, B621, and R623 to 8V. And then, the first scan signal corresponds to a low voltage such that the gates of the sub-pixels of the first row are off.

Similarly, the second scan signal is transferred to the sub-pixels of the second row (including sub-pixels B631, G632, R633 of the third pixel 630, and sub-pixels B641, G642, R643 of the fourth pixel 640). When the second scan signal corresponds to a high level, the gates of the sub-pixels of the second row are on. This also makes the sub-pixels of the second row be pre-charged by the data signal 8V and the common line modulated signal 0V or the data signal 2V and the common line modulated signal 10V before the pixel voltage changes from 1V to 3V.

In addition, when the second scan signal corresponds to a high level voltage, because the sub-pixels B631, R633, and G642 correspond to a positive polarity data line 8V, this data line 8V can cooperate with the common voltage of the common line 1, which maintains 0V as high as the voltage when the first scan signal corresponds to a high level, to pre-charge the sub-pixels B631, R633, and G642 to 8V. At the same time, the sub-pixels G632, B641, R643 correspond to a negative polarity data line 2V. This data line 2V can cooperate with the common voltage of the common line 2, which is modulated from 5V to 10V, to pre-charge the sub-pixels G632, B641, R643 to 8V. And then, the second scan signal corresponds to a low voltage such that the gates of the sub-pixels of the second row are off.

Furthermore, the third scan signal is transferred to the sub-pixels of the third row (including sub-pixel B651, G652, R653 of the fifth pixel 650, and sub-pixels B661, G662, R663 of the sixth pixel 660). When the third scan signal corresponds to a high level, the gates of the sub-pixels of the third row are on. This also makes the sub-pixels of the third row be pre-charged by the data signal 8V and the common line modulated signal 0V or the data signal 2V and the common line modulated signal 10V before the pixel voltage changes from 1V to 3V.

In addition, when the third scan signal corresponds to a high level voltage, because the sub-pixels B651, R653, and G662 correspond to a positive polarity data line 8V, this data line 8V can cooperate with the common voltage of the common line 3, which is modulated from 5V to 0V, to pre-charge the sub-pixels B651, R653, and G662 to 8V. At the same time, the sub-pixels G652, B661, and R663 correspond to a negative polarity data line 2V. This data line 2V can cooperate with the common voltage 10V of the common line 2 to pre-charge the sub-pixels G652, B661, and R663 to 8V. When the third scan signal corresponds to a high level, the first scan signal corresponds to a high level. Because the sub-pixels B611, R613, and G622 correspond to the positive polarity data line 8V, the data line 8V can cooperate with the common voltage of the common line 1, which is back to 5V, to charge the sub-pixels B611, R613, and G622 to the target voltage 3V. Simultaneously, the sub-pixel G612, B621, and R623 corresponds to a negative data line 2V. The data line 2V can cooperate with the common voltage of the common line 0, which is back to 5V, to charge the sub-pixels G612, B621, and R623 to the target voltage 3V.

And then, the fourth scan signal corresponds to a high level such that the gates of the sub-pixels of the fourth row are on, and so on. In this way, the over-driving operation can be finished in a frame period.

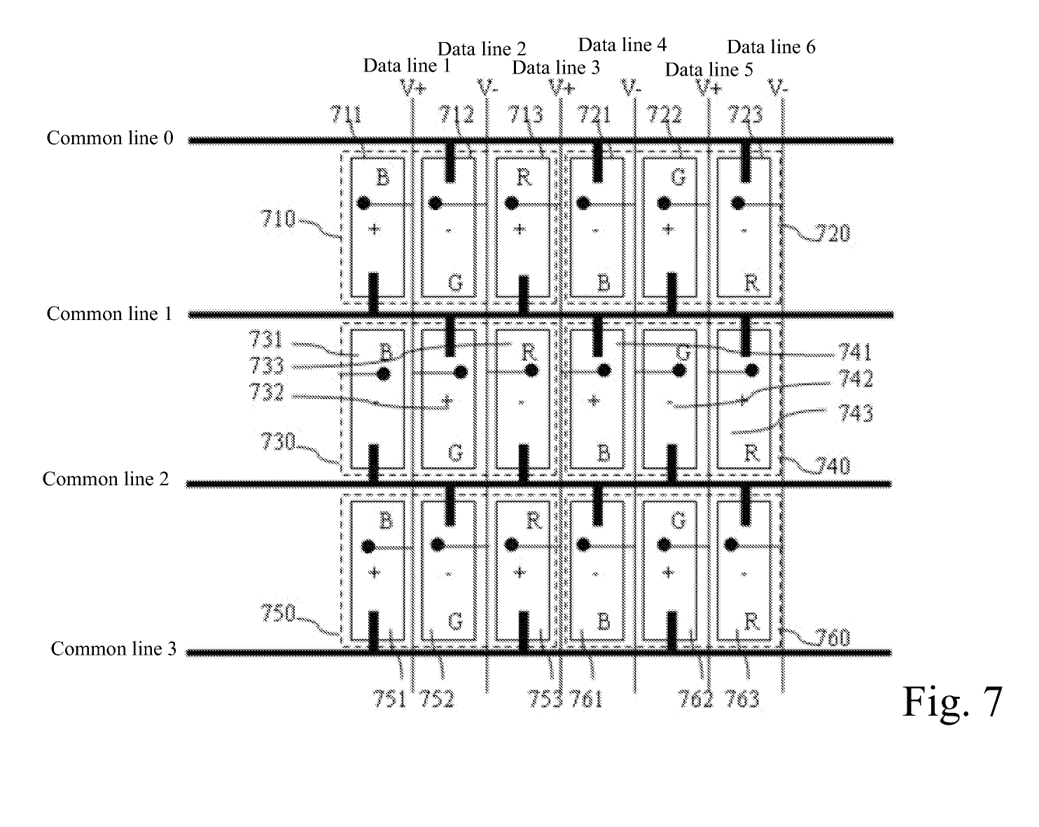

Please refer to FIG. 7, which is a diagram showing a part of the LCD device according to a fourth embodiment of the present invention. Similar to the third embodiment, in this embodiment, the pixels are also driven by a column driving configuration. Furthermore, in this embodiment, the LCD device comprises a plurality of vertical-strip pixels, and each vertical-strip pixel is composed of three vertical-strip sub-pixels (sub-pixel R, sub-pixel G, and sub-pixel B). As shown in FIG. 6, the sub-pixels R, G, and B are arranged in a horizontal direction. The pixel 710 and the pixel 720 are adjacent in the same row, the pixel 730 and the pixel 740 are adjacent in the same row, and so on.

The data lines are coupled according to Flip-pixel configuration. This means that a specific data line is only coupled to odd sub-pixels or even sub-pixels such that the odd sub-pixels and even sub-pixels corresponding to the same column can have different polarities. To speak more specifically, the data line 1 is coupled to the sub-pixel B711 of the first pixel 710, the sub-pixel G732 of the third pixel 730, and the sub-pixel B751 of the fifth pixel 750. The data line 2 is coupled to the sub-pixel G712 of the first pixel 710, the sub-pixel R733 of the third pixel 730, and the sub-pixel G752 of the fifth pixel 750. The data line 3 is coupled to the sub-pixel R713 of the first pixel 710, the sub-pixel B741 of the fourth pixel 740, and the sub-pixel R753 of the fifth pixel 750, and so on.

The common lines 1, 2, and 3 are orthogonal to the data lines, and they form an array. In this embodiment, a specific common line is alternatively coupled to the sub-pixels adjacent to the specific common line. As shown in FIG. 7, the common line 1 is coupled to the sub-pixels B711 and R713 of the first pixel 710, the sub-pixel G722 of the second pixel 720, the sub-pixel G732 of the third pixel 730, the sub-pixels B741 and R743 of the fourth pixel 740. The common line 2 is coupled to the sub-pixels B731 and R733 of the third pixel 730, the sub-pixel G742 of the fourth pixel 740, the sub-pixel G752 of the fifth pixel 750, the sub-pixels B761 and R763 of the sixth pixel 760. The coupling configuration of the common 3 is shown in FIG. 7 and thus omitted here.

In addition, the pixel 710 is adjacent to the pixel 720, and they have opposite polarities. Furthermore, the pixel 710 is adjacent to the pixel 730, and they have opposite polarities, also. In FIG. 7, adjacent sub-pixels have opposite polarities.

Please refer to FIG. 7 in conjunction with FIG. 4. The first scan signal is transferred to the sub-pixels of the first row (including sub-pixels B711, G712, R713 of the first pixel 710, and the sub-pixels B721, G722, R723 of the second pixel 720). When the first scan signal corresponds to a high level, the gates of the sub-pixels of the first row are on. This makes the sub-pixels of the first row be pre-charged by the data signal 8V and the common line modulated signal 0V or the data signal 2V and the common line modulated signal 10V before the pixel voltage changes from 1V to 3V.

In addition, when the first scan signal corresponds to a high level voltage, because the sub-pixels B711, R713, and G722 correspond to a positive polarity data line 8V, this data line 8V can cooperate with the common voltage of the common line 1, which is modulated from 5V to 0V, to pre-charge the sub-pixels B711, R713, and G722 to 8V. At the same time, the sub-pixels G712, B721, and R723 correspond to a negative polarity data line 2V. This data line 2V can cooperate with the common voltage 10V of the common line 0 to pre-charge the sub-pixels G712, B721, and R723 to 8V. And then, the first scan signal corresponds to a low voltage such that the gates of the sub-pixels of the first row are off.

Similarly, the second scan signal is transferred to the sub-pixels of the second row (including sub-pixels B731, G732, R733 of the third pixel 730, and sub-pixels B741, G742, R743 of the fourth pixel 740). When the second scan signal corresponds to a high level, the gates of the sub-pixels of the second row are on. This also makes the sub-pixels of the second row be pre-charged by the data signal 8V and the common line modulated signal 0V or the data signal 2V and the common line modulated signal 10V before the pixel voltage changes from 1V to 3V.

In addition, when the second scan signal corresponds to a high level voltage, because the sub-pixels G732, B741, and R743 correspond to a positive polarity data line 8V, this data line 8V can cooperate with the common voltage of the common line 1, which maintains 0V as high as the voltage when the first scan signal corresponds to a high level, to pre-charge the sub-pixels G732, B741, and R743 to 8V. At the same time, the sub-pixels B731, R733, G742 correspond to a negative polarity data line 2V. This data line 2V can cooperate with the common voltage of the common line 2, which is modulated from 5V to 10V, to pre-charge the sub-pixels B731, R733, G742 to 8V. And then, the second scan signal corresponds to a low voltage such that the gates of the sub-pixels of the second row are off.

Furthermore, the third scan signal is transferred to the sub-pixels of the third row (including sub-pixel B751, G752, R753 of the fifth pixel 750, and sub-pixels B761, G762, R763 of the sixth pixel 760). When the third scan signal corresponds to a high level, the gates of the sub-pixels of the third row are on. This also makes the sub-pixels of the third row be pre-charged by the data signal 8V and the common line modulated signal 0V or the data signal 2V and the common line modulated signal 10V before the pixel voltage changes from 1V to 3V.

In addition, when the third scan signal corresponds to a high level voltage, because the sub-pixels B751, R753, and G762 correspond to a positive polarity data line 8V, this data line 8V can cooperate with the common voltage of the common line 3, which is modulated from 5V to 0V, to pre-charge the sub-pixels B751, R753, and G762 to 8V. At the same time, the sub-pixels G752, B761, and R763 correspond to a negative polarity data line 2V. This data line 2V can cooperate with the common voltage 10V of the common line 2 to pre-charge the sub-pixels G752, B761, and R763 to 8V. When the third scan signal corresponds to a high level, the first scan signal corresponds to a high level. Because the sub-pixels B711, R713 and G722 correspond to the positive polarity data line 8V, the data line 8V can cooperate with the common voltage of the common line 1, which is back to 5V, to charge the sub-pixels B711, R713 and G722 to the target voltage 3V. Simultaneously, the sub-pixels G712, B721, and R723 correspond to a negative data line 2V. The data line 2V can cooperate with the common voltage of the common line 0, which is back to 5V, to charge the sub-pixels G712, B721, and R723 to the target voltage 3V.

And then, the fourth scan signal corresponds to a high level such that the gates of the sub-pixels of the fourth row are on, and so on. In this way, the over-driving operation can be finished in a frame period.

According to the above-mentioned embodiments, the present invention driving method for driving the LCD device includes following steps: utilizing the scan driving module to generate scan signals and transferring the scan signals to the scan lines; utilizing the data driving module to generate data signal and transferring the data signals to the data lines; utilizing the scan lines to transfer the scan signals to at least one sub-pixel of the pixels to row-by-row scan sub-pixels located in a same column; utilizing the data lines to pre-charge at least one sub-pixel of the pixels, and to transfer the data signals to the sub-pixel in order to display an image. Furthermore, the above driving method can further includes the following step: utilizing common lines to provide a high voltage or a low voltage to the sub-pixels coupled to the common lines.

Those skilled in the art will readily observe that numerous modifications and alterations of the device may be made while retaining the teachings of the invention. Accordingly, the above disclosure should be construed as limited only by the metes and bounds of the appended claims.

1. A liquid crystal display (LCD) display, characterized in that the LCD comprises:
a scan driving module, for generating scan signals;
data driving module, for generating data signals;
a thin film transistor (TFT) array panel having pixels, each of the pixels comprises a sub-pixel R, a sub-pixel G, and a sub-pixel B;
scan lines, coupled to at least one sub-pixel of the pixels, for receiving the scan signals from the scan driving module to row-by-row scan the sub-pixels located on a same column;
data lines, coupled to at least one sub-pixel of the pixels, for receiving the data signals from the data driving module, pre-charging the sub-pixel before transferring the data signals to the sub-pixel, and transferring the data signals to display an image; and
common lines, coupled to at least one sub-pixel of the pixels, for providing a high voltage or a low voltage according to a polarity of the sub-pixel coupled to the common line;
wherein the sub-pixels R, G and B are arranged in a horizontal direction or a vertical direction of a scanning direction of scanning the sub-pixels, the common line is orthogonal to the scanning direction of scanning the sub-pixels, and two adjacent pixels have opposite polarities.

2. The LCD device of claim 1, characterized in that each of the common lines is coupled to the sub-pixels having a same polarity.

3. The LCD device of claim 1, characterized in that each of the data lines is coupled to the sub-pixels having a same polarity.

4. An LCD device, characterized in that the LCD device comprises:
a scan driving module, for generating scan signals;
a data driving module, for generating data signals;
a TFT array panel having pixels, each of the pixels comprises a sub-pixel R, a sub-pixel G, and a sub-pixel B;
scan lines, coupled to at least one sub-pixel of the pixels, for receiving scan signals from the scan driving module, to row-by-row scan the sub-pixels located on a same column; and
data lines, coupled to at least one sub-pixel of the pixels, for receiving the data signals from the data driving module, pre-charging the sub-pixel before transferring the data signals to the sub-pixel, and transferring the data signals to display an image.

5. The LCD device of claim 4, characterized in that the LCD device further comprises:
common lines, coupled to at least one sub-pixel of the pixels, for providing a high voltage or a low voltage according to a polarity of the sub-pixel coupled to the common line.

6. The LCD device of claim 4, characterized in that the sub-pixels R, G and B are arranged in a horizontal direction of a scanning direction of scanning the sub-pixels.

7. The LCD device of claim 4, characterized in that the sub-pixels R, G and B are arranged in a vertical direction of a scanning direction of scanning the sub-pixels.

8. The LCD device of claim 6, characterized in that the common line is orthogonal to the scanning direction of scanning the sub-pixels.

9. The LCD device of claim 4, characterized in that two adjacent pixels have opposite polarities.

10. The LCD device of claim 9, characterized in that each of the common lines is coupled to the sub-pixels having a same polarity.

11. The LCD device of claim 9, characterized in that each of the data lines is coupled to the sub-pixels having a same polarity.

12. A driving method for driving an LCD device, characterized in that: the LCD device comprises a scan driving module, a data driving module, a TFT array panel, scan lines, and data lines, the TFT array panel have pixels, each of the pixels comprises a sub-pixel R, a sub-pixel G, and a sub-pixel B, the driving method comprises:
(A) utilizing the scan driving module to generate scan signals and transferring the scan signals to the scan lines;
(B) utilizing the data driving module to generate data signal and transferring the data signals to the data lines;
(C) utilizing the scan lines to transfer the scan signals to at least one sub-pixel of the pixels to row-by-row scan sub-pixels located in a same column;
(D) utilizing the data lines to pre-charge at least one sub-pixel of the pixels, and to transfer the data signals to the sub-pixel in order to display an image.

13. The driving method of claim 12, characterized in that the driving method further comprises:
(E) utilizing common lines to provide a high voltage or a low voltage to the sub-pixels coupled to the common lines.

14. The LCD device of claim 7, characterized in that the common line is orthogonal to the scanning direction of scanning the sub-pixels.
